(19) United States
(12) Patent Application Publication
(10) Pub. No.: US 2003/0091411 A1
(43) Pub. Date: May 15, 2003

(54) Automated storage extraction system

(76) Inventor: Ronald C. Diehm, Olney, MD (US)

Correspondence Address: Richard T. Peterson, Kilpatrick Stockton LLP, Suite 900, 607 14th Street, N.W., Washington, DC, 20005, US

(21) Appl. No.: 09/987,101

(22) Filed: Nov. 13, 2001

(51) Int. Cl. B65G 1/00

(52) U.S. Cl. 414/280

(57) ABSTRACT

An automated storage and retrieval system platform extraction and insertion mechanism has a left and right pin transport engaged by a chain on said platform along a path extending substantially the length of the platform in a substantially elliptical pathway such that either the left and right pin transports travel from a first end of the platform substantially the length of the platform and optionally back to the first end. The left and right transport paths are identical in their direction along their paths. The left and right transport paths have a two directional movement about the platform along the path; and a left and right pin mounted upon the left and right pin transports whereby the left or right pin is pointed substantially away from the path, wherein the left or right pin engage an underside of a container extension and pull a container until the left or right pin has substantially traversed the platform. The left and right transport paths are substantially offset from each other along the platform.

### BACKGROUND OF THE INVENTION

1. Field of the Invention

This invention relates to automated storage container extraction, and more specifically to a rotating pin system for automated extraction and insertion of containers in a storage rack.

2. Description of the Related Art

High density storage is often associated with the delivery and storage of very large amounts of materials that are up to 500 pounds in weight. 500 pounds per container aggregate is categorized as a “mini-load.” A material weight of 500 pounds or more, however, is not untypical. This load is optimally stored by an automated storage and retrieval system (AS/RS).

AS/RS conventionally has parallel racks of storage slots arranged in a grid of horizontal and vertical arrays. A track lays in an aisle between two opposing storage racks for the guidance of a stacker. The stacker is an industrial robot that extracts or inserts containers or bins in and out of the storage rack and to and from a workstation. The containers are adapted to be placed by horizontal sliding movement into the rack. The containers further have a vertically extending rim or edge portion around the entire periphery thereof. The containers also typically have handles or tool engaging means for facilitating the horizontal movement of the containers onto and off the storage rack by the stacker.

The workstation, often located at the end of the storage racks, allows an AS/RS user to obtain materials via the stacker from high density storage. Additionally, an AS/RS user may store materials at the workstation by placing the container on the stacker to be inserted in the storage racks. Alternatively, the stacker may place a container on a conveyor located at one or more proximities of the storage racks. The delivery points can be at the front, rear, top, bottom, or middle of the racks.

The stacker is a columnar structure that moves along the track to access the storage racks in a horizontal direction and optionally towards the workstation. A platform moves in a vertical direction on the column to access the storage racks in a vertical direction. The platform extends across the aisle between the opposing storage racks. An extractor, mounted on the platform, automatically retrieves or inserts a container to the storage rack. A cross-over occurs when the platform extractor retrieves a container from one storage rack or work station and inserts the container in the opposing storage rack or work station.

Various types of extraction devices have been proposed in conjunction with the automated storage and retrieval systems. Magnetic extractors have been used to engage a magnetic plate attached to the end of each bin or container. This is adaptable to very light containers, and because of the space occupied by the magnet assembly on the platform, it is suitable only for extraction and subsequent replacement back in the same lateral direction from which the container was extracted.

Hook extractors have also been adapted to cooperate with a special handle on the end of the container, by rotating a hook into an upright position inside the inverted L-shaped recess in the handle. The extracted container is removed on a pair of endless belts which support the container and reduce strain on the hook. The disadvantage of this type of mechanism is that it requires the greatest number of sensors and that the system is unduly complicated with traversing hooks, solenoids and belts.

A drop hook extraction mechanism employs a hook traversing a platform to extract a container. The hook pivots upwardly to engage a container handle. The sliding hook pulls the container onto the platform. The container is then deposited back into the same storage rack as this mechanism has no crossover capability. To return the container, the hook pivot downwardly and pushes the container back into a storage position.

Another type of extraction system involves insertion of a lifter platform beneath a container, lifting and withdrawing it. This system results in much lost space in the storage rack, since vertical spacing between container supports must be provided to allow insertion of the lift or shuttle platform and lifting of the container from the supports prior to extraction. The vertical lifting motion also wastes time, making the overall system less efficient.

Extractors often utilize single pull mechanisms to extract or insert the containers. Single pull mechanisms require reacquisition of the extractor every time an extraction or insertion is required on an opposing side. This cycle can take longer than a horizontal and vertical reacquisition at particular workstations or in certain situations.

Further extraction mechanisms include those designed as two continuous belts, each with a single pin. One design has a pair of continuous loops, each with a radially inner and outer pins spaced along it. The bilateral extraction systems are taught to be an improvement since they enable extraction and then transfer in either lateral direction once the container is extracted, i.e., providing for bilateral insertion of the container into the storage rack on either side of the aisle. These systems, however, are often not crossover capable or require additional moving parts such as a separate carriage to raise the pins under the handle of the container.

In the shifting table system, a two-dimensionally displaceable platform is required to first traverse the aisle without interference with the containers, and then to extend arm-like extractor elements into the storage location past the front edge of a container for engagement with the sides of the container thereby providing withdrawal of the container from the array, and similar reinsertion of the container into the same or a different storage location. While this system is viable for the storage of a multiplicity of articles in light of the many locations for insertion and extraction of containers, the shifting table system creates issues of complexity relative to the need for two-dimensional movement of the platform, and is thus typically not economically justifiable for storage requirements. The successful operation of this type of extraction system depends on precise positioning of the handles of the modular containers residing throughout the matrix and misalignment of a particular container may result in faulty engagement of the system.

Extraction mechanisms involving fingers or bars that travel rotationally about a sprocket in order to extend into alignment with the lip of a container sought to be removed employ a rotational path of alignment until the finger or bar is engaged. This mechanism is taught to need sufficient distance between vertically displaced containers such that the finger or bar, as it moves rotationally into alignment with the lip of the container to be extracted, does not collide with the container below. The distance between the bins in such an arrangement is related to the radius of the circle traversed by the finger or pin about the sprocket that drives the finger or pin into alignment. The same sprocket with chain assembly is both the driving force for engagement with the lip or extension, as well as for moving the finger or pin as the bin is extracted or inserted. These chains with fingers, driven by sprockets are certainly known in the art. Some of these designs, however, do not provide crossover and require the repositioning of the finger each time the finger needs to be used to engage a container lip or handle. The additional time need for the finger or pin to reposition is disadvantageous in such an automated system.

In summary, the prior designs teach a variety of arrangements for effecting extraction and return of an array-supported storage container. Some require highly specialized or complex structural elements and assemblies that are unnecessarily subject to breakdowns or which typically require realignment or repair. Other operatively grip or grasp or otherwise engage the bins in a fashion that is somewhat less reliable or stable or secure than desired or that does not permit the apparatus to extract bins containing unusually heavy articles. Still others do not provide capability for crossover between storage racks across the aisle.

### BRIEF SUMMARY OF THE INVENTION

An automated storage and retrieval system platform extraction and insertion mechanism has a left and right pin transport engaged by a path determining member on the platform along a path extending substantially the length of the platform in a substantially elliptical pathway such that either the left and right pin transports travel from a first end of the platform substantially the length of the platform and optionally back to the first end. The left and right transport are directionally identical. The left and right transport paths having a two directional movement about the platform along the path. Left and right pins are mounted upon the left and right pin transports whereby the left or right pin is pointed substantially away from the path. The left or right pin engage an underside of a container through the side of the extension and pull a container until the left or right pin has substantially traversed the platform. The left and right transport paths are substantially offset from each other along the platform. The path determining member substantially changes angle of direction around a sprocket member. A motor engages the path determining member for providing movement of the left and right transports.

### BRIEF DESCRIPTION OF THE DRAWING

The invention description below refers to the accompanying drawings, of which:

FIG. 1 is a perspective view of an embodiment of the invention.

### DETAILED DESCRIPTION OF THE INVENTION

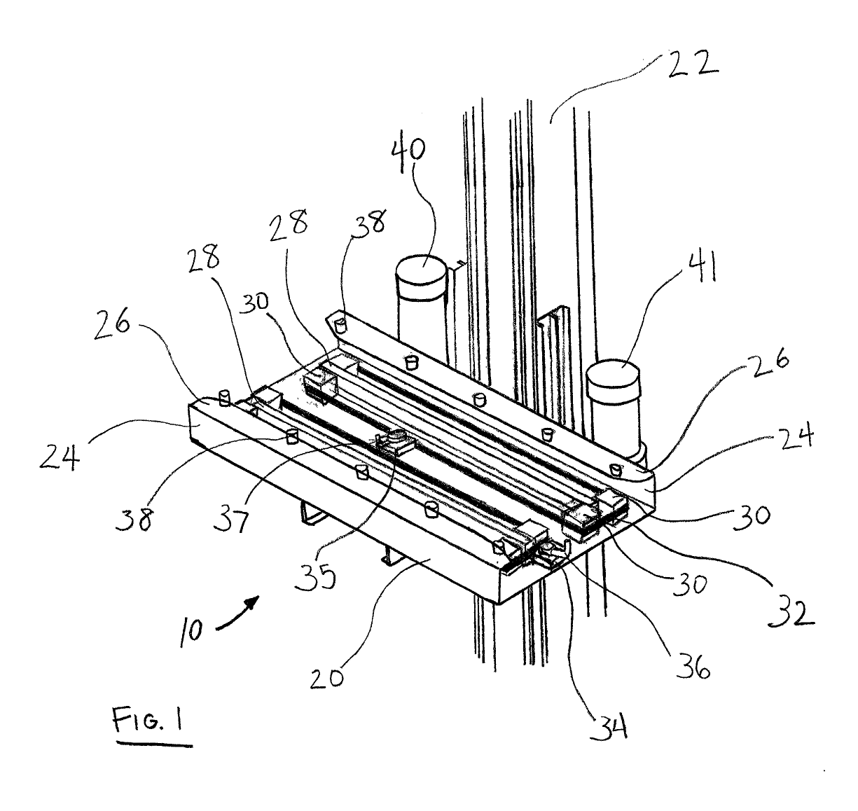

As shown in FIG. 1 of the drawings, an automated storage and retrieval system has an extraction mechanism 10 on a platform 20 that is slidably engaged to a column 22. The platform 20 has two opposing walls 24 extending upwards. Walls 24 extend inwardly to approximate an upper platform surface 26. Two rails 28 are mounted on the platform 20. The rails 28 extend substantially along the length of the platform 20. The rails 28 extend upwardly, but not past the upper platform surface 26. Sprockets or pulley members 30 are mounted at the ends of the rails 28. Two sprockets 30 are mounted at the end of each rail 28. Optionally, one sprocket 30 only may be mounted at the end of each rail 28. The sprockets 30 guide a path determining member 32 around the rails 28. The path determining member 32 is preferably a continuous section of double 40 chain. The sprockets 30 on the left and right rails 28 are not identical in their positioning along the length of the platform 20. The offset optimizes the extraction and insertion of containers by positioning the path for the minimal distance traveled to retrieve or eject a container.

A left and right pin transport 34, 35 are engaged to the chain 32 so as to be driven around the sprockets 30. The sprockets 30 drive the chains 32 in one direction for extraction, and drive the chains 32 in the other direction for insertion. The sprockets 30 also drive the chain 32 in the same direction around the rails 28 so that the left and right pin transports 34, 35 are moving in different directions when traversing the center of the platform 20 between the rails 28. A left and right pin 36, 37 is mounted upon the left and right pin transports 34, 35. The pin 36, 37 extends radially outward from the elliptical shape of the chain 32 around the sprockets 30. This positioning of the pins 36, 37 allows for engagement with a container, preferably by the underside of a handle, as the pin 36, 37 enters through the side of a handle. The pin 36, 37 traverses the platform 20 down a center passageway, pulling the container for substantially the length of the platform 20. As the pin 36, 37 turns around the sprocket 30, the pin 36, 37 disengages from the handle. Either pin 36, 37 may then reengage with a container handle to slide the container off of the platform 20. One pin 36, 37 is dedicated to the extraction and insertion of containers on the left side of a storage rack or workstation. The other pin 36, 37 is dedicated to the extraction and insertion of containers on the right side of a storage rack or workstation.

Upper platform surface 26 has guides 38 for maintaining proper placement and direction of a container on the platform 20. Left and right gear motor units 40, 41, attached to the platform 20 and slidably engaged with the column 22, provide power to at least one left or right sprocket 30 for chain 32 movement.

Two position switches, “left home” and “right home,” are used to track the pin 36, 37 location on the platform 20. The location of the pins 36, 37 may be tracked and operated by a process control system, such as a personal computer or a distal controller. To retrieve a container, the designated (left or right) pin 36, 37 is rotated clockwise from its normal home position or the “retrieve” home position switch. The left pin 36 normally sits on the right home position. The retrieve position switch is where the pin will normally start from to pull a container from the rack onto the platform 20. The pin 36, 37 will also stop at the retrieve position at the end of a restore or deposit cycle, which is the process of returning the container to the storage rack or depositing the container at a workstation.

A retrieve ends with the pin 36, 37 arriving at the “bin on” position switch or the opposite home (left/right) switch to the retrieve home position. Pulls by the right pin 37 or left pin 36 position the container in the identical position on the platform 20 (bin off/handoff position). This allows a crossover from one side to the opposite side since either pin 36, 37 can latch into the required handle to complete the deposit or restore function. Because the pins 36, 37 operate independently of each other, a retrieve may be started from one of the platform 20 while a restore is in progress by the other pin 36, 37.

The present invention does not require a shifting table. The drive system consists of a continuous motion chain/pin assembly without any end stops. Having tow systems, one for the left and one for the right, splits the load, duty cycle and wear and tear equally between the two units, as opposed to a single mechanism for both sides.

The pins 36, 37 are never required to reposition while the horizontal and vertical drive systems of the column 22 and platform 20 are active. Many of the extraction systems that are capable of “crossing over,” or pulling the container from one side and then depositing the container on the opposite side, require some repositioning of the extraction device. To reduce cycle time, the repositioning occurs during the horizontal and vertical movement. This can lead to the rare event of the mechanism over-traveling the stop position and placing itself or the container into the storage aisle while the stacker is traveling. This event can lead to serious system or material damage. Even with safety sensors flagging the motor controllers, the inertia of the stacker in high speed will cause some damage.

The platform cycle time is never compromised for pin reacquisition. At power up, the pins will go through a home initialization routine if they are not at the appropriate home.

It will be obvious to those having skill in the art that many changes may be made in the above-described details of a preferred embodiment of the present invention without departing from the underlying principles thereof. The scope of the present invention should, therefore, be determined only by the following claims.

What is claimed is:

1. An automated storage and retrieval system platform extraction and insertion mechanism, said mechanism comprising:
a left and right pin transport engaged by a path determining member on said platform along a path extending substantially the length of said platform in a substantially elliptical pathway such that either said left and right pin transports travel from a first end of said platform substantially the length of said platform and optionally back to said first end;
said left and right transport paths being directionally identical;
said left and right transport paths having a two directional movement about said platform; and
a left and right pin mounted upon said left and right pin transports whereby said left or right pin is pointed substantially away from said path;
wherein said left or right pin engage an underside of a container extension and pull a container until said left or right pin has substantially traversed said platform.

2. The mechanism as recited in claim 1, wherein said left and right transport paths are substantially offset from each other along said platform.

3. The mechanism as recited in claim 1, wherein said path determining member is a chain.

4. The mechanism as recited in claim 1, wherein said path determining member substantially changes angle of direction around a sprocket member.

5. The mechanism as recited in claim 4, further comprising two sprocket members for each said left and right transport paths.

6. The mechanism as recited in claim 4, further comprising four sprocket members for each said left and right transport paths.

7. The mechanism as recited in claim 1, further comprising a motor engaged to said path determining member for providing movement of said left and right transports.

8. A method for extracting or inserting containers in an automated storage and retrieval system, said method comprising the steps of:
providing a platform having a left and right pin transport engaged by a path determining member on said platform along a path extending substantially the length of said platform in a substantially elliptical pathway such that either said left and right pin transports travel from a first end of said platform substantially the length of said platform and optionally back to said first end; said left and right transport paths being directionally identical; said left and right transport paths having a two directional movement about said platform; and a left and right pin mounted upon said left and right pin transports whereby said left or right pin is pointed substantially away from said path; wherein said left or right pin engage an underside of a container extension and pull a container until said left or right pin has substantially traversed said platform;
moving said left or right transport along its path until said left or right pin is substantially underneath a container extension;
engaging a container extension with said left or right pin;
pulling a container substantially across said platform;
disengaging a container extension with said left or right pin;
transporting a container on said platform to a destination;
reengaging a container extension with said left or right pin; and
pulling a container substantially across said platform to a final destination.

9. The method as recited in claim 8, further comprising the step of:
returning said left or right transport to a home position on said path while not in use.

10. The method as recited in claim 8, further comprising the step of:
allowing either said left or right pin to engage a container on either side of said platform.

11. An automated storage and retrieval system for extracting and inserting containers in an array of storage slots, said automated storage and retrieval system comprising:
a column for traversing an array of storage slots;
a platform slidably engaged on said column;
opposing walls on said platform extending upwards and inwardly to approximate an upper platform surface;
two rails mounted on said platform extending substantially along the length of said platform and extending upwardly, but not past said upper platform surface;
a plurality of sprockets mounted at the ends of said rails;
a path determining member rotating around said sprockets;
a left and right pin transport engaged to said path determining member;
a left and right pin mounted upon said left and right pin transports;
said pin extending radially outward from the elliptical shape of said path determining member about said sprockets;
whereby the positioning of said pins allows for engagement with a container, preferably by the underside of a handle, as said pin enters through the side of a handle, the pin then traverses said platform down a center passageway, pulling the container for substantially the length of said platform, said pin disengaging from a handle as said pins turns around said sprocket, and either said left or right pin may then reengage with a container handle to slide the container off of said platform.

12. The automated storage and retrieval system as recited in claim 11, wherein said sprockets drive path determining member in only two directions.

13. The automated storage and retrieval system as recited in claim 11, wherein said sprockets drive said path determining member of said left and right pin transports in the same direction around said rails whereby said left and right pin transports are moving in different directions when traversing said center passageway.

14. The automated storage and retrieval system as recited in claim 11, wherein said left or right pin is dedicated to the extraction and insertion of containers on one of the left or right side of a storage rack or workstation.

15. The automated storage and retrieval system as recited in claim 11, wherein said left and right transport paths are substantially offset from each other along said platform.
